(19) United States
(12) Patent Application Publication
(10) Pub. No.: US 2011/0168107 A1
(43) Pub. Date: Jul. 14, 2011

(54) Animal Restraining Device

(76) Inventors: Abraham Yaniv, Tel Aviv (IL); Arnona Gazit, Tel Aviv (IL); Michael F. Brown, West Milford, NJ (US); Francis Gomes, Lincoln Park, NJ (US); David Landsberger, Caldwell, NJ (US)

(21) Appl. No.: 12/687,253

(22) Filed: Jan. 14, 2010

(51) Int. Cl. A01K 15/04

(52) U.S. Cl. 119/751

(57) ABSTRACT

The present invention provides an animal restraining device to securely accommodate the animal and further prevent it from escaping the device. The device includes a substantially cylindrical shaped body having a front end, a rear end and a cavity. The front end includes an opening to the cavity for passage of the animal during loading and unloading of the animal. The device also includes a slot formed in the body configured to receive a tab following the loading of the animal in the cavity in order to block the animal from escaping the device. The device further includes an access opening formed on the top portion to permit access to body of the animal.

### BACKGROUND OF THE INVENTION

1. Field of the Invention

The present invention relates to devices for restraining animals. More particularly, it relates to an animal restraint which can be used to restrain substantially all of an animal during the administration of an injection.

2. Description of Related Art

Animal restraining devices are known in the art and commonly used in the laboratories to temporarily restrain an animal (e.g. a mouse) while they are being examined, medicated or treated.

One such restraining device is disclosed in U.S. Pat. No. 5,109,801 (herein the ‘801 patent’) in which the animal is held in a tubular sleeve with closures for securely restraining the animal's body. Although the device described in the '801 patent secures the animal, the closures of the device disadvantageously provide a strong force into the animal's body which may hurt or injure the animal. Another disadvantage of the device in the '801 patent is that in order to lead the animal into the device such that the animal's head protrudes from the opening, one must manually slide the device over the animal's body until its head extends through the opening. Furthermore, the tubular sleeve is required to be made of fabric or mesh material in order to allow contact with the animal while the animal is inside the restraining device of the '801 patent.

Another restraining device known in the art is disclosed in U.S. Pat. No. 7,617,800 (herein the '800 patent). The device in the '800 patent is an animal restraining shield comprising a planar sheet having an aperture. The perimeter of the sheet is sized to permit a head of the animal to pass through from a back side to a front side of the aperture. The shield is shaped, sized and positioned according to the shape and/or size of the animal to prevent movement of the animal. In a preferred embodiment, pluralities of notches are cut into the shield to facilitate the removal of the shield from the animal. Since, the only portion of the animal accessible to an operator is the neck and/or head; any contact on treatment is restricted to only these parts of the body. More specifically, the device of the '800 patent is suited only for oral administration of medication to the animal. Furthermore, because the restraining action of the device is dependent on precisely sizing and shaping the shield to match the dimensions of the subject animal, it is difficult to prevent animals of varying sizes from escaping the shield.

Thus, in order to overcome the disadvantages of the prior art, there is a need in the art to provide an animal restraining device that securely accommodates an animal and further restrain the animal from escaping from the device. There is also a need in the art for an animal restraining device that allows for easy loading and unloading of the animal. There is a further need in the art for an animal restraining device which provides for easy access to a plurality of parts of the animal's body in order to permit an operator to perform variety types of treatment or medicating procedures.

### SUMMARY OF THE INVENTION

The present invention provides an animal restraining device for securely and safely restraining an animal in the device.

The present invention also provides an animal restraining device for easy loading and unloading of the animal from the device.

The present invention further provides an animal restraining device having an access point to be in contact with the animal.

The present invention even further provides an animal restraining device having an ability to restrain the animals of varying sizes and dimensions.

In one embodiment of the present invention, the animal restraining device includes a substantially cylindrically shaped body having a front end, a rear end, and a cavity. The front end has an opening to the cavity for passage of the animal during loading and unloading of the animal. At least one slot is formed in the body such that the slot is configured to receive a tab following the loading of the animal in the cavity, wherein the tab confines the animal in a loaded position. The device also includes a base supporting the body.

### BRIEF DESCRIPTION OF THE DRAWINGS

The present invention will be more readily understood from the detailed description of exemplary embodiments presented below considered in conjunction with the attached drawings, of which:

FIG. 1A illustrates a front side view of an animal restraining device in accordance with an embodiment of the present invention;

FIG. 1B illustrates a rear side view of the animal restraining device in accordance with an embodiment of the present invention;

FIG. 1C is a cross-sectional view according to section line 1-1 of FIG. 1A; and

FIG. 1D is a cross-sectional view according to section line 2-2 of FIG. 1B.

### DETAILED DESCRIPTION OF THE INVENTION

The present invention relates to an animal restraining device configured to accommodate animals of various shapes and sizes. The device is designed to securely accommodate an animal and firmly restrain the animal within a cavity of the device. The device is also designed to allow an operator to easily and safely access the animal loaded in the device.

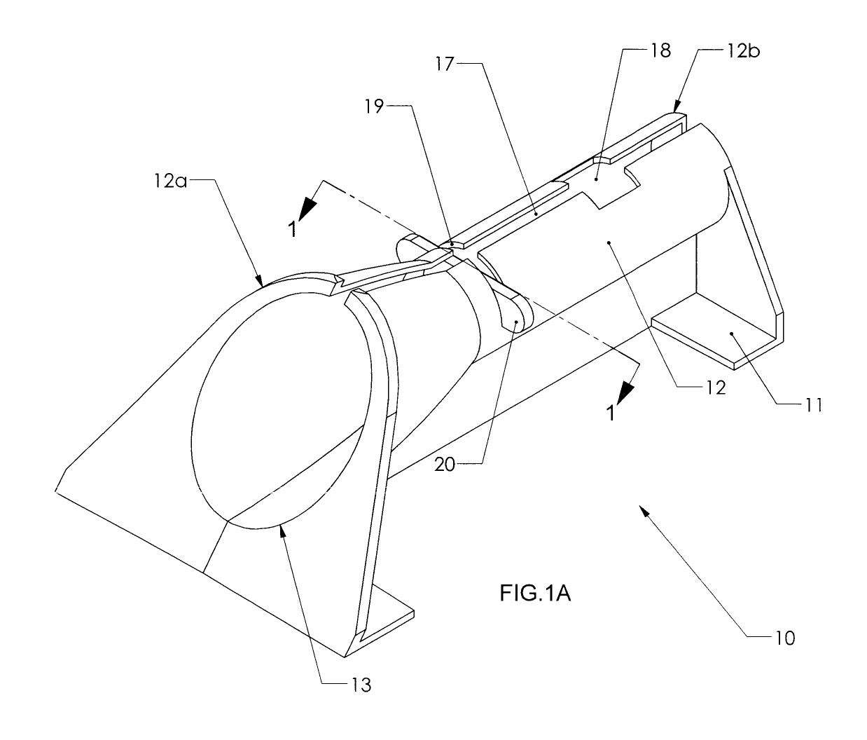

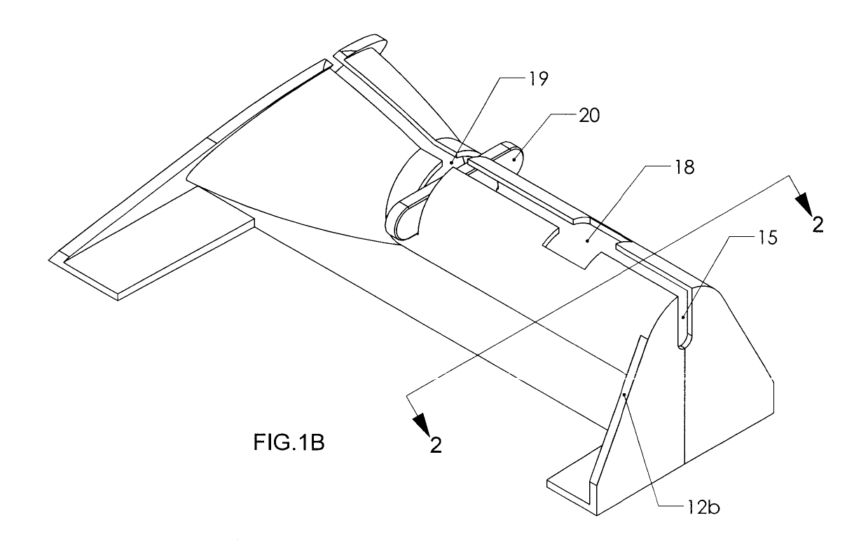

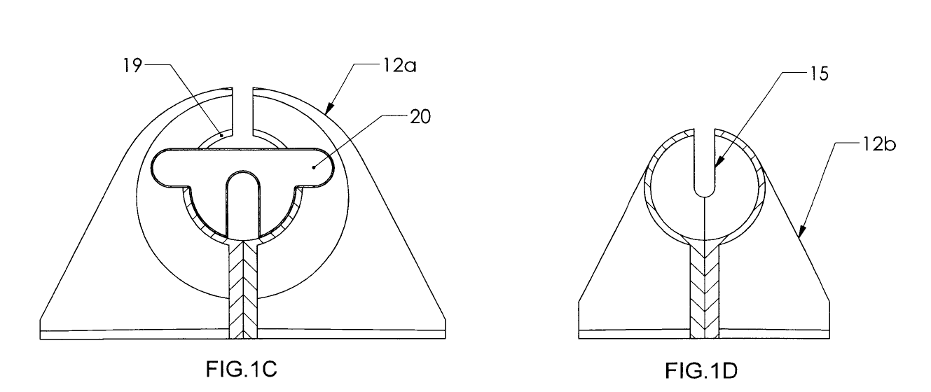

FIGS. 1A and 1B depict an exemplary animal restraining device 10 according to one embodiment of the present invention. FIG. 1A is a front side view and FIG. 1B is the rear side view of the animal restraining device 10. The restraining device 10 includes a label front part of base 11 in FIG. 1A and a substantially cylindrically shaped body 12 supported by the base 11. Both the base 11 and the body 12 are preferably made of any suitable plastic material such as, for example, Polyethylene (PE), Polymethylpentene (PMP), Polypropylene (PP), Polystyrene (PS) etc. However, one skilled in the art would appreciate that the base 11 and the body 12 can be constructed of other materials such as wood, fiberglass, metal, etc. It is noted that the body 12 as shown in FIGS. 1A and 1B is substantially cylindrical in shape, however, the invention is not limited to a cylindrical form and the body 12 may be another suitable shape such as, for example, circular, rectangular, triangular, square, etc.

As shown in FIGS. 1A and 1B, the body 12 includes a front end 12a and a rear end 12b. The front end 12a has an opening 13, which leads to a substantially conically shaped portion of a cavity 16. According to an embodiment of the present invention, the front end 12a includes a sloped surface 14 to facilitate loading of the animal into the cavity 16. It is noted that the portion of the cavity 16 at the front end 12a illustrated in FIG. 1A is substantially cone shaped, however, the invention is not limited to this form and the front end portion of the cavity 16 may be another suitable shape such as circular, rectangular, triangular, square, etc.

The rear end 12b of the device 10 is illustrated in FIG. 1B and in the cross-section view in FIG. 1D. According to an embodiment of the present invention, the rear end 12b includes an aperture 15 sized to preferably allow for a tail of the animal to be placed outside the restrainer 10 once the animal is in a loaded position as will be described below. The aperture 15 at the rear end 12b as illustrated in FIGS. 1B and 1D is substantially U-shaped, however, one skilled in the art would appreciate that the aperture 15 may be another suitable shape.

Referring back to FIGS. 1A and 1B, top portion of the body 12 a track 17 is provided along a top portion of the body 12. The track 17 extends horizontally and parallel to the cavity 16 from the front end 12a to the rear end 12b. The track 17 functions to provide access to body of the animal. The restrainer 10 also includes an access opening 18 extending outward from the track 17 to each side of the cylindrical shaped body 12. The access opening 18 as shown in FIGS. 1A and 1B is sized just enough to allow for easy access to animal's skin in order to conduct procedure to the animal. The access opening 18 is preferably enlarged to provide enough space for a user to either press or pull on the animal's skin in order to inject the animal. It is noted that the access opening 18 as shown in FIG. 1A is substantially square in shape, however, the embodiments are not limited to this form and may comprise other suitable shapes, such as circular, semi-circular, rectangular, triangular, etc.

As shown in FIGS. 1A and 1B, the body 12 further comprises at least one slot 19 extending perpendicular to the track 17. The slot 19 is adapted to receive a tab 20 such as the tab 20 shown in FIG. 1A. Upon insertion, the tab 20 engages within the slot 19 preferably after placing the animal in the device to prevent the animal from escaping the device 10. Although the figures illustrate a single slot 19, one skilled in the art will appreciate that more than one slot 19 may be included to provide the flexibility for selecting the slot suitable for placement of the tab based on the length/height of the animal. Specifically, the tab 20 may be securely inserted into the slot 19 to prevent the animal from moving forward towards opening 13 on the front end 12a, and confine the animal in a loaded position, as will be described below.

The cross-section view of FIG. 1C illustrates the tab 20 in place inside the slot 19 of the body 12, across inside of the cavity 16, which extends from the sloped surface 14 at the front end 12a to the rear end 12b.

In accordance with an embodiment of the present invention, in order to load the animal, for example, a mouse into the device 10, a user picks up the mouse by its tail and aligns the tail in the track 17 while pulling it towards the rear end 12b. The user then continues to slide the mouse into a back portion of the cavity 16 to securely load the mouse such that the tail hangs out from the aperture 15 on the rear end 12b. In this manner, the animal is placed in the loaded position. After the mouse is placed in the loaded position, the user inserts the tab 20 into the slot 19 to prevent the animal from moving forward to the front end 12a and escaping from the device 10. Once, in the loaded position, the user may access the animal via the access opening 18. Further, in order to unload the animal, the user removes the tab 20 from the slot 19 to allow the animal to escape from the device 10.

Although various embodiments that incorporate the teachings of the present invention have been shown and described in detail herein, those skilled in the art can readily devise many other varied embodiments that still incorporate these teachings without departing from the spirit and the scope of the invention.

1. An animal restraining device comprising:
a substantially cylindrically shaped body having a front end, a rear end, and a cavity, said front end having an opening to the cavity for passage of the animal during loading and unloading of the animal;
at least one slot formed in said body, said at least one slot configured to receive a tab following the loading of the animal in the cavity, wherein the tab confines the animal in a loaded position; and
a base supporting the body.

2. The device according to claim 1 wherein said front end comprises a sloped surface surrounding the opening to facilitate loading of the animal into the cavity.

3. The device of claim 3 wherein said cavity extends from the sloped surface to the rear end of the body.

4. The device according to claim 1 wherein said device further comprising a top portion having a track extending from the front end to the rear end, said track provides access to the animal.

5. The device according to claim 4 wherein the track at the top portion extends parallel to the cavity inside the body.

6. The device according to claim 4, wherein said slot extends perpendicularly from the track to each side of the cylindrical shaped body.

7. The device according to 6 further comprising an access opening formed on the top portion, said access opening extends outward from the track to permit access to body of the animal.

8. The device according to claim wherein said rear end having an aperture for tail end of the animal.
